(19) United States
(12) Patent Application Publication
(10) Pub. No.: US 2026/0349672 A1
(43) Pub. Date: Nov. 5, 2026

(54) USING AN ARTIFICIAL INTELLIGENCE APPLICATION CLASSIFICATION FRAMEWORK TO FACILITATE GENERATION OF A DEVELOPMENT TEMPLATE FOR AN ARTIFICIAL INTELLIGENCE APPLICATION

(71) Applicant: The Boeing Company, Arlington, VA (US)

(72) Inventor: Alexander BELLEMARE-DAVIS, Vancouver (CA)

(21) Appl. No.: 19/194,419

(22) Filed: Apr. 30, 2025

(51) Int. Cl. G06F 8/34; G06F 8/36

(52) U.S. Cl. CPC G06F 8/34; G06F 8/36

(57) ABSTRACT

A system provides, for display, a graphical user interface (GUI) that presents information associated with an AI application classification framework. The system obtains, based on providing the GUI, a first input indicating a functional role of an AI application to be developed and a second input indicating an output type of the AI application to be developed, wherein the functional role and the output type are associated with the AI application classification framework. The system determines, based on the first input and the second input, a set of one or more prevention barriers for causes of a threat event and a set of one or more mitigation barriers for consequences of the threat event. The system generates, based on the set of one or more prevention barriers and the set of one or more mitigation barriers, a development template for developing the AI application.

### FIELD

The present disclosure relates generally to generating a development template for an artificial intelligence (AI) application, and to using an AI application classification framework to facilitate generation of a development template for the AI application.

### BACKGROUND

An AI application is designed to perform tasks that typically require human intelligence, such as decision-making. An AI application can include machine learning models that learn from data, as well as other AI techniques such as rule-based systems, expert systems, and neural networks, depending on the AI application's design and objectives.

### SUMMARY

An embodiment of the present disclosure provides an AI application development system, comprising: one or more memories; and one or more processors, communicatively coupled to the one or more memories, configured to: provide, for display, a graphical user interface (GUI) that includes a window, wherein the window comprises a section that presents information associated with an AI application classification framework; obtain, based on providing the GUI, a first input indicating a functional role of an AI application to be developed and a second input indicating an output type of the AI application to be developed, wherein the functional role and the output type are associated with the AI application classification framework; determine, based on the first input and the second input, a set of one or more prevention barriers for causes of a threat event and a set of one or more mitigation barriers for consequences of the threat event; generate, based on the set of one or more prevention barriers and the set of one or more mitigation barriers, a development template for developing the AI application; and provide, for display, via the window of the GUI, at least a portion of the development template to enable development of the AI application.

Another embodiment of the present disclosure provides a method, comprising: obtaining, by an AI application development system, based on providing a GUI, a first input indicating a functional role of an AI application to be developed and a second input indicating an output type of the AI application to be developed, wherein the functional role and the output type are associated with an AI application classification framework; determining, by the AI application development system, based on the first input and the second input, a set of one or more prevention barriers for causes of a threat event and a set of one or more mitigation barriers for consequences of the threat event; generating, by the AI application development system, based on the set of one or more prevention barriers and the set of one or more mitigation barriers, a development template for developing the AI application; and providing, by the AI application development system, for display, via the GUI, at least a portion of the development template to enable development of the AI application.

Yet a further embodiment of the present disclosure provides a non-transitory computer-readable medium storing a set of instructions, the set of instructions comprising: one or more instructions that, when executed by one or more processors of an AI application development system, cause the AI application development system to: obtain input indicating at least one of a functional role of an AI application to be developed or an output type of the AI application, wherein the functional role and the output type are associated with an AI application classification framework; determine, based on the input, at least one of a set of one or more prevention barriers or a set of one or more mitigation barriers; and generate, based on the at least one of the set of one or more prevention barriers or the set of one or more mitigation barriers, a development template for developing the AI application.

The features, functions, and advantages described herein can be achieved independently in various implementations or can be combined in other implementations, further details of which are shown in the drawings and described below.

### BRIEF DESCRIPTION OF THE DRAWINGS

FIG. 1 is a diagram of an example implementation associated with using an AI application classification framework to facilitate generation of a development template for an AI application.

FIG. 2 is a diagram of an example bowtie framework associated with using an AI application classification framework to facilitate generation of a development template for an AI application.

FIGS. 3A-3C are diagrams of an example implementation associated with using an AI application classification framework to facilitate generation of a development template for an AI application.

FIG. 4 is a diagram of an example environment in which systems and/or methods described herein may be implemented.

FIG. 5 is a diagram of example components of a device associated with using an AI application classification framework to facilitate generation of a development template for an AI application.

FIGS. 6-8 are flowcharts of example processes associated with using an AI application classification framework to facilitate generation of a development template for an AI application.

### DETAILED DESCRIPTION

The following detailed description of example implementations refers to the accompanying drawings. The same reference numbers in different drawings identify the same or similar elements.

There are many different types of AI applications, each with varying decision-making capabilities, ranging from providing assistance in human decision-making to fully autonomous decision-making. As the number of AI applications grows, it becomes increasingly crucial to ensure that these applications are developed with proper barriers to prevent or mitigate any potential threat events associated with use of the applications. For instance, an AI application designed to assist in human decision-making should not be used for autonomous decision-making, as doing so could result in adverse consequences.

However, ensuring that all necessary barriers are defined and implemented during development of an AI application is a challenging task. Often, potential threat events are overlooked or not considered, especially when the threat events fall outside an originally intended scope of operation of the AI application. Overlooking these threat events can introduce challenges that affect the AI application's reliability and performance. Additionally, identifying and addressing threat events after development often requires modifying or updating the AI application, which may lead to inefficient use of computing resources (e.g., processing resources, memory resources, communication resources, and/or power resources, among other examples). Such post-hoc updates can also extend development timelines and delay deployment, potentially impacting the AI application's overall efficiency and usability. Therefore, incorporating appropriate barriers during an initial development phase helps to streamline the development process, optimize resource utilization, and enhance the AI application's consistency and effectiveness.

Some implementations described herein facilitate development of an AI application using an AI application classification framework. A user can interact with a GUI that is provided by an AI application development system to specify characteristics of an AI application that is to be developed, such as the AI application's functional role and output type (e.g., both of which are defined by the AI application classification framework). Upon receiving this input, the AI application development system identifies a relevant threat event associated with the specified characteristic and thereby determines (e.g., such as through a bowtie framework approach) a set of one or more prevention barriers to reduce the likelihood of the threat event occurring and a set of one or more mitigation barriers to minimize an impact of the threat event if, or when, the threat event does occur.

To guide the development process, the AI application development system generates a development template that incorporates parts associated with the set of one or more prevention barriers and the set of one or more mitigation barriers. The development template requires the user to provide necessary details, such as configuration parameters and implementation specifications, for each barrier to ensure that the AI application is developed with appropriate safeguards for the threat event.

Integrating prevention and mitigation barriers early in a development phase provides a proactive approach to structuring AI applications, ensuring that the AI applications align seamlessly with intended roles and functionalities. This not only enhances an AI application's consistency and effectiveness, but also enables greater reliability and predictability in the AI application's performance. Furthermore, establishing barriers at an outset of AI application's development allows for a more efficient allocation of computing resources (e.g., processing resources, memory resources, communication resources, and/or power resources, among other examples), reducing a need for reconfigurations after significant development has already taken place. By embedding risk management directly into the development process, the AI application development system streamlines AI development, accelerates time-to-deployment, and optimizes overall resource utilization.

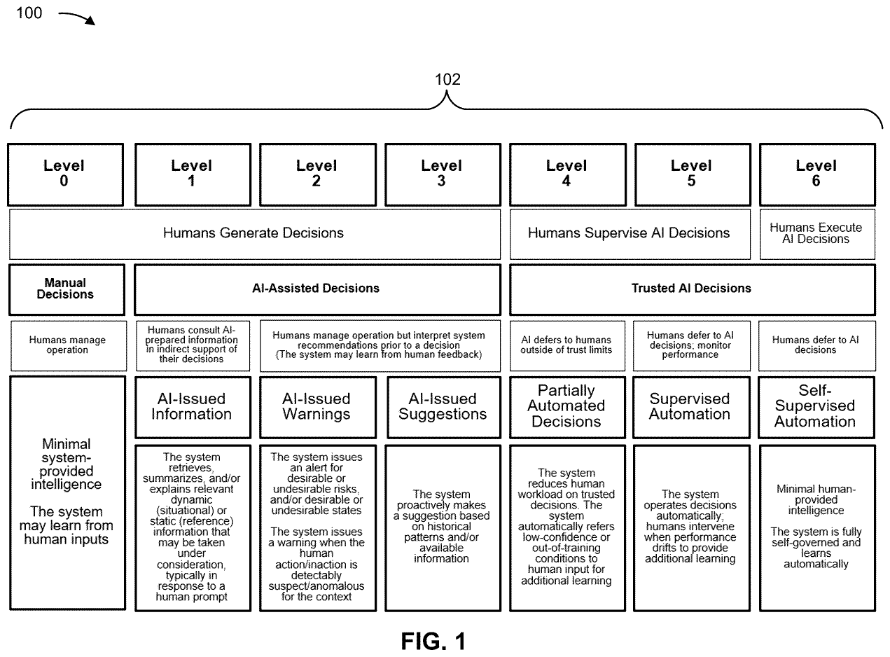

FIG. 1 is a diagram of an example implementation 100 associated with using an AI application classification framework to facilitate generation of a development template for an AI application. As shown in FIG. 1, example implementation 100 includes an AI application classification framework 102.

As shown in FIG. 1, the AI application classification framework 102 defines varying classifications, shown as levels, of decision-making capabilities for AI applications (also referred to as AI systems, or just systems). At level 0, “Humans manage operation,” a human is primarily responsible for decision-making and the AI application provides minimal intelligence to assist the human in the decision-making. At level 1, “Humans consult AI-prepared information in indirect support of their decisions,” the AI application retrieves, summarizes, and/or explains relevant dynamic (e.g., situational) or static (e.g., reference) information (e.g., by providing definitions and/or summary explanations, and/or performing natural-language database querying, semantic searching, and/or retrieval-augmented-generation (RAG)) that can be taken under consideration by a human, such as in response to a human-entered prompt (e.g., a prompt for information). At levels 2 and 3, “humans manage operation but interpret system recommendations prior to a decision,” the AI application provides a warning (level 2) or a suggestion (level 3) that can be taken under consideration by a human. For example, at level 2, the AI application issues an alert for desirable or undesirable risks, and/or desirable or undesirable state and/or issues a warning when a human action, or inaction, is detectably suspect or anomalous (e.g., within a context of a decision-making of the human). As another example, at level 3, the AI application proactively makes a suggestion (e.g., based on historical patterns and/or other available information) to facilitate human decision-making.

At level 4, “AI defers to humans outside of trust limits,” the AI application is configured to reduce human workload on trusted decisions, such as by automatically executing decision-making within boundaries of the trusted decisions. Accordingly, the AI application can also automatically refer low-confidence or out-of-training conditions to a human for human decision-making, and can use any human input for additional learning (e.g., to update or improve the AI application). At level 5, “Humans defer to AI decisions; monitor performance,” the AI application is configured to automatically execute decision-making. Accordingly, a human may intervene when performance of the AI application drifts (e.g., changing operation conditions results in a decline in accuracy, reliability, or effectiveness of the AI application), such as to provide additional learning (e.g., to update or improve the AI application). At level 6, “Humans defer to AI decisions,” the AI application is fully self-governed and learns automatically, and therefore minimal human-provided intelligence (e.g., to facilitate decision-making and/or additional learning) is needed.

Accordingly, as further shown in FIG. 1, a level may be associated with a functional role of an AI application. For example, level 0 may be associated with an AI-low-assistance role (represented as “Manual Decisions”), levels 1-3 may each be associated with an AI-assistance role (represented as “AI-Assisted Decisions”), and levels 4 through 6 may each be associated with an AI-trusted role (represented as “Trusted AI Decisions”). Additionally, a level may be associated with an output type of the AI application. For example, level 0 may be associated with a minimal output type (represented as “Minimal system-provided intelligence”); level 1 may be associated with an information retrieval type (represented as “AI-Issued Information”); level 2 may be associated with an alerting type (represented as “AI-Issued Warnings”); level 3 may be associated with a suggestion delivery type (represented as “AI-Issued Suggestions”); level 4 may be associated with an automated decision type, such as a partially automated decision type (represented as “Partially Automated Decisions”); level 5 may be associated with an automated decision type, such as a supervised automation decision type (represented as “Supervised Automation”); and level 6 may be associated with an automated decision type, such as a self-supervised automation decision type (represented as “Self-Supervised Automation”). Accordingly, the levels may be categorized based on a human's role in decision-making with respect to operation of the AI application. For example, the levels 0 through 3 may be categorized as human-directed decision-making (represented as “Humans Generate Decisions”); levels 4 and 5 may be categorized as human-supervised decision-making (represented as “Humans Supervise AI Decisions”); and level 6 may be categorized as human-excluded decision-making (represented as “Humans Execute AI Decisions”).

As indicated above, FIG. 1 is provided as an example. Other examples may differ from what is described with regard to FIG. 1. For example, the AI application classification framework 102 may include additional levels, fewer levels, different levels, or differently defined levels. For example, a level may be associated with a different functional role (or a differently defined functional role) of an AI application, with a different output type (or a differently defined output type) of the AI application, and/or with a different categorization (or a differently defined categorization) of human decision-making.

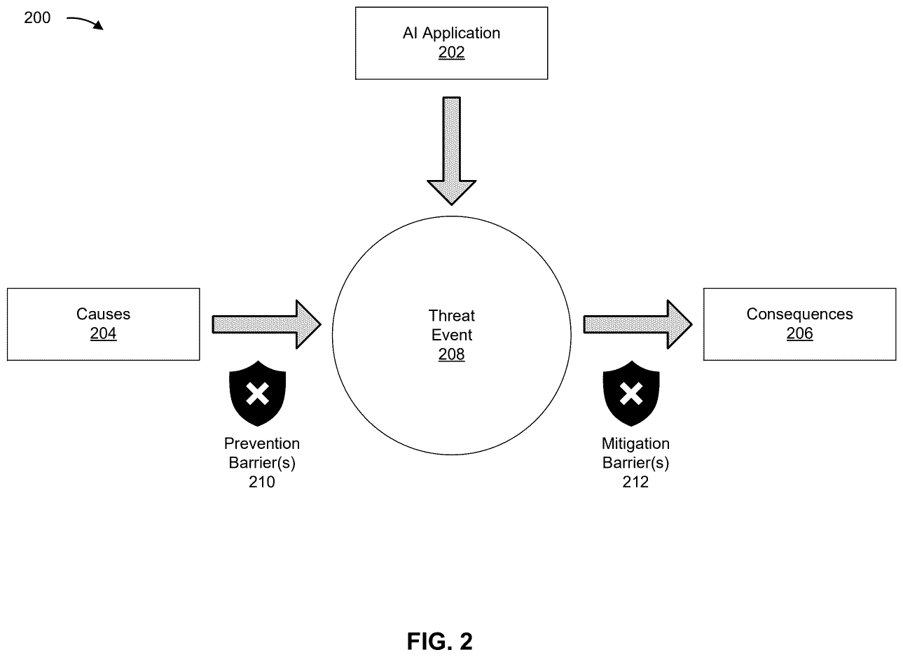

FIG. 2 is a diagram of an example bowtie framework 200 associated with using an AI application classification framework to facilitate generation of a development template for an AI application. As shown in FIG. 2, the example bowtie framework 200 is a risk assessment and management tool for an AI application 202, that visually represents pathways from causes 204 to consequences 206 of a threat event 208. The bowtie framework 200 resembles a bowtie shape, hence the name.

The causes 204 (shown on the left side of the bowtie) are factors that could lead to the threat event 208 (shown at a center of the bowtie), which is a specific threat event associated with operation of the AI application 202. The consequences 206 (shown on a right side of the bowtie) are negative outcomes that could result from the threat event 208.

As further shown in FIG. 2, the bowtie framework 200 may include a set of one or more prevention barriers 210 (shown at the left side of the bowtie) for the causes 204 of the threat event 208 and/or a set of one or more mitigation barriers 212 (shown at the right side of the bowtie) for the consequences 206 of the threat event 208. The set of one or more prevention barriers 210 may prevent (or reduce a likelihood of) the causes 204 from leading to the threat event 208. The set of one or more mitigation barriers 212 may minimize the consequences 206 if the threat event 208 occurs.

The example bowtie framework 200 is provided as an example of a risk assessment and management tool that can be used to facilitate generation of a development template for an AI application (e.g., an AI application 202), as described elsewhere herein. Descriptions of implementations provided throughout this document use terminology aligned with the example bowtie framework 200 described herein.

As indicated above, FIG. 2 is provided as an example. Other examples may differ from what is described with regard to FIG. 2.

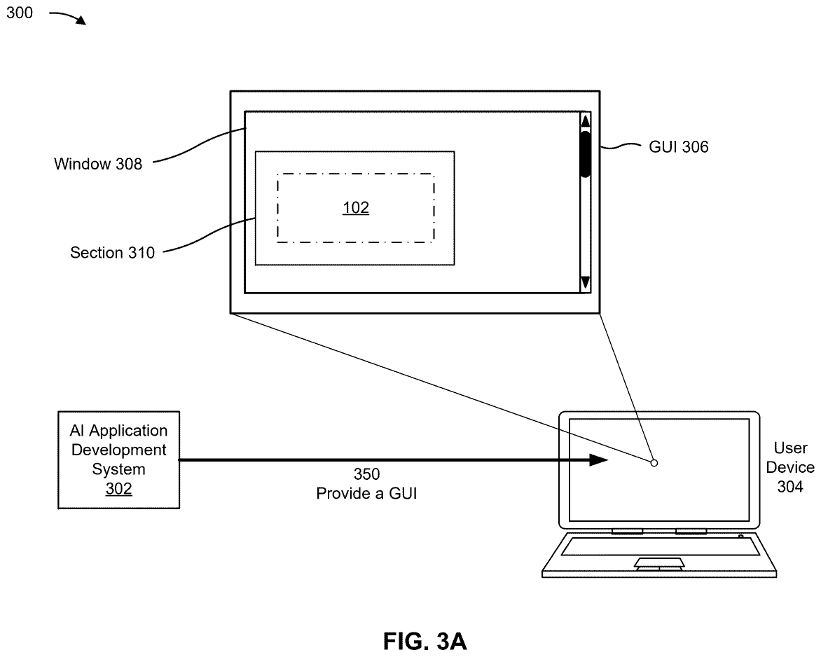

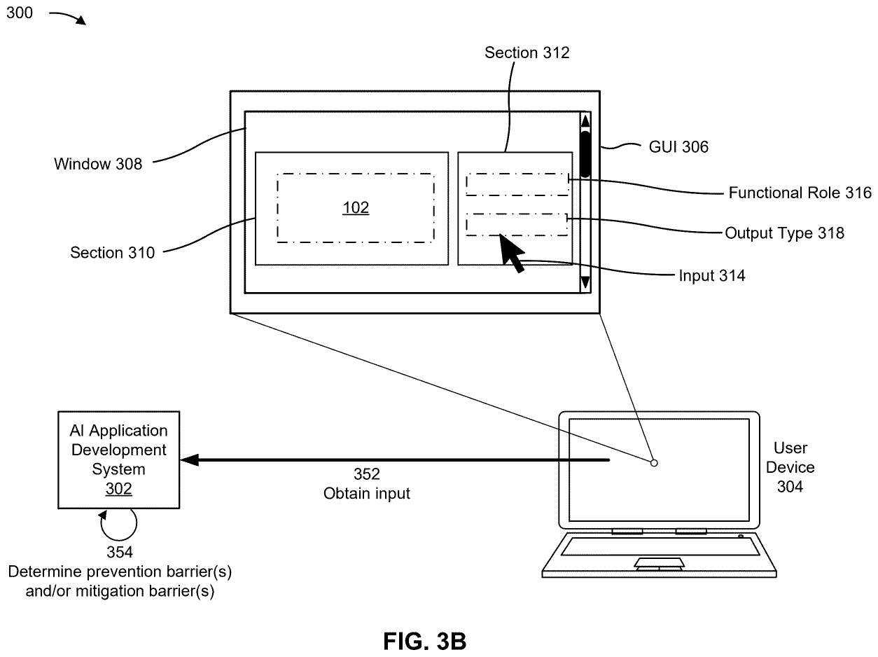

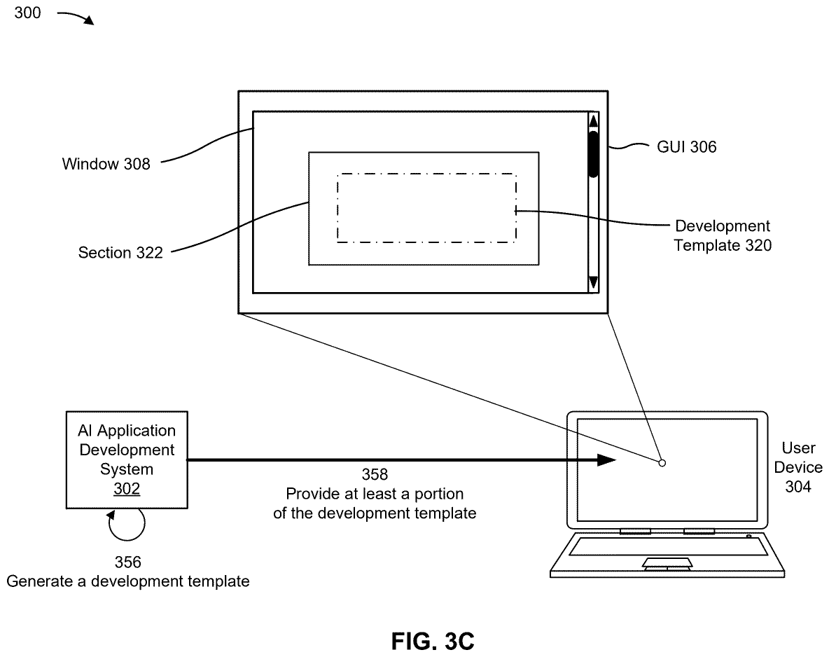

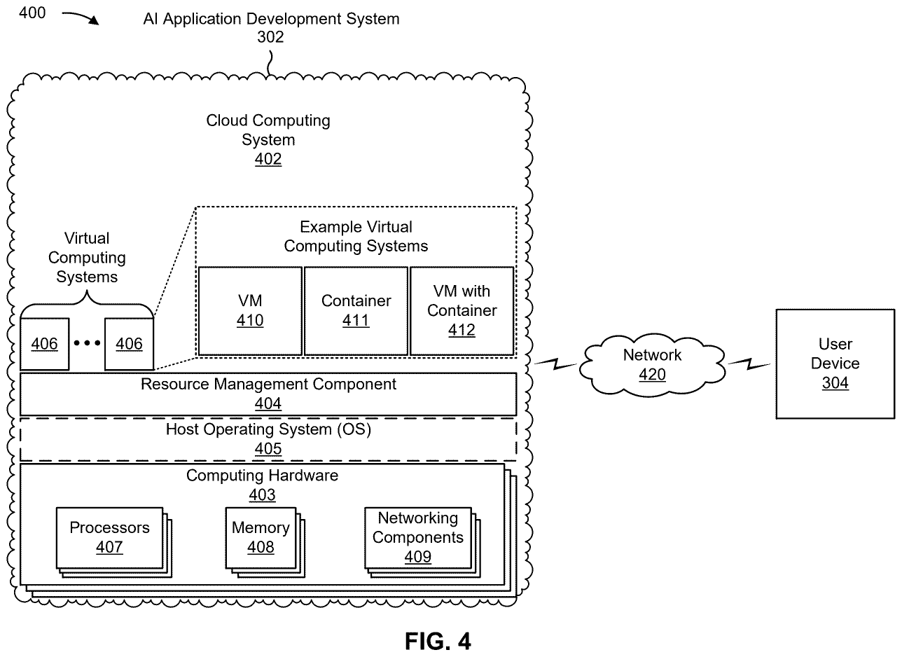

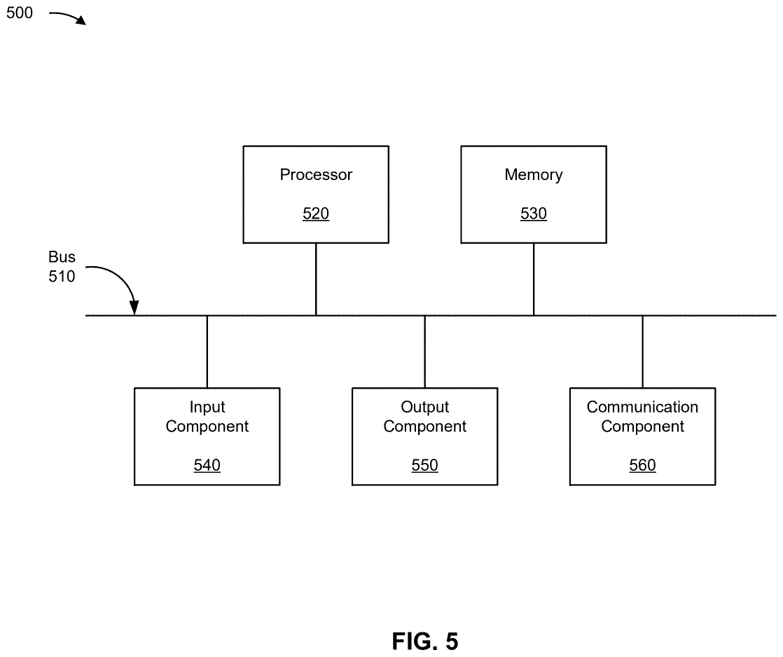

FIGS. 3A-3C are diagrams of an example implementation 300 associated with using an AI application classification framework to facilitate generation of a development template for an AI application. As shown in FIGS. 3A-3C, example implementation 300 includes an AI application development system 302 and a user device 304, which are described in more detail below in connection with FIG. 4 and FIG. 5.

The AI application development system 302 is configured to facilitate development of an AI application (e.g., an AI application that is to be developed), such as an AI application 202. Accordingly, the AI application development system 302 may be configured to provide a GUI 306 for display, as further described herein.

As shown in FIGS. 3A-3C, the user device 304 includes a display screen, which is configured to display the GUI 306 (e.g., based on the AI application development system 302 providing the GUI 306 for display to the user device 304). The user device 304 also includes an input component, which is configured to allow a user of the user device 304 to interact (e.g., by “clicking on”, selecting, and/or inputting information, among other examples) with the GUI 306, as further described herein.

As shown in FIG. 3A, and by reference number 350, the AI application development system 302 provides the GUI 306 for display. For example, as shown in FIG. 3A, the AI application development system 302 may provide the GUI 306 to the user device 304 (e.g., by sending the GUI 306 to the user device 304), which may cause the user device 304 to display the GUI 306 via the display screen of the user device 304. The GUI 306 is associated with development of an AI application (e.g., an AI application that is to be developed, such as an AI application 202). That is, the GUI 306 is an interface for displaying information related to generation of a development template for developing the AI application (e.g., a template that helps structure and guide development of the AI application).

As shown in FIGS. 3A-3B, the GUI 306 includes a window 308. The window 308 may comprise a section 310 (also referred to as a first section 310). The section 310 may present (e.g., for display) information associated with an AI application classification framework, such as the AI application classification framework 102. For example, the section 310 may display information about one or more classifications (e.g., one or more levels) of the AI application classification framework 102 (e.g., as shown in FIG. 1).

As further shown in FIG. 3B, the window 308 may additionally comprise a section 312 (also referred to as second section 312). In some implementations, the section 312 may include one or more input features, such as one or more selectable indicators (e.g., buttons, links, tabs, or other types of selectable indicators), that allow a user of the user device 304 to enter information associated with the AI application that is to be developed, including details aligned with the AI application classification framework. For example, the section 312 may include a feature for indicating a functional role of the AI application, a feature for indicating an output type of the AI application, a feature for indicating a classification (e.g., a level) of the AI application, and/or another feature aligned with the AI application classification framework.

As shown in FIG. 3B, and by reference number 352, the AI application development system 302 obtains input 314 (e.g., based on providing the GUI 306). In some implementations, a user of the user device 304 interacts with the GUI 306 (e.g., via the input component of the user device 304) to allow the AI application development system 302 to obtain the input 314. The user of the user device 304 may interact with the one or more input features of the section 312 of the window 308 to enter the input 314. For example, the user may select a selectable indicator (e.g., by “tapping,” “clicking,” or otherwise engaging the selectable indicator) of the section 312 to enter the input 314. This then causes the AI application development system 302 to receive the input 314 (e.g., from the user device 304).

The input 314 may indicate information associated with the AI application that is to be developed, such as in relation to the AI application classification framework (e.g., the AI application classification framework 102). For example, the input 314 may indicate a functional role 316 of the AI application and/or an output type 318 of the AI application, as shown in FIG. 3B, both of which are associated with the AI application classification framework. In some implementations, the input 314 may indicate other information associated with the AI application, such as a classification (e.g., a level) of the AI application, which is also associated with the AI application classification framework.

While the input 314 is shown as a singular input, the input 314 may comprise one or more inputs (e.g., one or more individual inputs). For example, the input 314 may comprise a first input indicating the functional role 316 of the AI application, a second input indicating the output type 318 of the functional role 316, and so on.

As shown by reference number 354, the AI application development system 302 determines a set of one or more prevention barriers and/or a set of one or more mitigation barriers. For example, with respect to the example bowtie framework 200 shown in FIG. 2, when the AI application to be developed is an AI application 202, the AI application development system 302 may determine a set of one or more prevention barriers 210 for causes 204 of a threat event 208 for the AI application 202 and/or a set of one or more mitigation barriers 212 for consequences 206 of the threat event 208.

In some implementations, the AI application development system 302 may determine the set of one or more prevention barriers and/or the set of one or more mitigation barriers based on the input 314. For example, the AI application development system 302 may determine, based on the input 314, the functional role 316 of the AI application and/or the output type 318 of the AI application. The AI application development system 302 may thereby determine that the threat event is a particular type of threat event (e.g., that is associated with the functional role 316 and/or the output type 318). The AI application development system 302 may cause (e.g., based on determining that the threat event is the particular type of threat event) a set of one or more prevention barriers that are associated with the particular type of threat event to be included in the set of one or more prevention barriers. Additionally, or alternatively, the AI application development system 302 may cause (e.g., based on determining that the threat event is the particular type of threat event) a set of one or more mitigation barriers that are associated with the particular type of threat event to be included in the set of one or more mitigation barriers.

In an example, the input 314 may indicate that the functional role 316 of the AI application is an AI-assistance role and that the output type 318 is an information retrieval type (both of which are associated with a level 1 decision-making capability of the AI application classification framework 102, as shown in FIG. 1). The AI application development system 302 may therefore determine, based on the input 314, that the threat event for the AI application is an erroneous information retrieval threat event (e.g., that is associated with the level 2 decision-making capability of the AI application classification framework 102). Accordingly, the AI application development system 302 may cause (e.g., based on determining that the threat event is an erroneous information retrieval threat event) a set of one or more erroneous information retrieval prevention barriers to be included in the set of one or more prevention barriers. Additionally, or alternatively, the AI application development system 302 may cause (e.g., based on determining that the threat event is an erroneous information retrieval threat event) a set of one or more erroneous information retrieval mitigation barriers to be included in the set of one or more mitigation barriers.

Accordingly, the set of one or more erroneous information retrieval prevention barriers may include, for example, at least one of a user competence barrier (e.g., a barrier to ensure that the user of the user device 304 possesses sufficient competence to recognize and address potential inaccuracies in information provided by the AI application), a usage validation barrier (e.g., a barrier to validate that information provided by the AI application is utilized in an indirect support capacity, and not as a sole basis for decision-making), or a redundancy barrier (e.g., a barrier to ensure that redundant systems or processes are configured to prevent an unquestioned acceptance or exercise of information provided by the AI application). Additionally, or alternatively, the set of one or more erroneous information retrieval mitigation barriers may include, for example, at least one of a cross-validation error barrier (e.g., a barrier to detect and reduce an impact of cross-validation errors during AI application deployment through monitoring, feedback, retraining, or model updates), a hallucination barrier (e.g., a barrier to identify and mitigate hallucinations comprising fabricated or unsupported information generated by the AI application), or an incorrect retrieval barrier (e.g., a barrier to identify and mitigate effects of incorrect retrieval of information from data sources).

In another example, the input 314 may indicate that the functional role 316 of the AI application is an AI-assistance role and that the output type 318 is an alerting type (both of which are associated with a level 2 decision-making capability of the AI application classification framework 102, as shown in FIG. 1). The AI application development system 302 may therefore determine, based on the input 314, that the threat event for the AI application is an erroneous alerting threat event (e.g., that is associated with the level 2 decision-making capability of the AI application classification framework 102). Accordingly, the AI application development system 302 may cause (e.g., based on determining that the threat event is an erroneous alerting threat event) a set of one or more erroneous alerting prevention barriers to be included in the set of one or more prevention barriers. Additionally, or alternatively, the AI application development system 302 may cause (e.g., based on determining that the threat event is an erroneous alerting threat event) a set of one or more erroneous alerting mitigation barriers to be included in the set of one or more mitigation barriers.

Accordingly, the set of one or more erroneous alerting prevention barriers may include, for example, at least one of a context-aware suppression barrier (e.g., a barrier that prevents the AI application from generating irrelevant warnings in known safe states or contexts) or a clarity barrier (e.g., a barrier to ensure that warning messages generated by the AI application are clear, interpretable, and actionable to minimize user confusion and incorrect responses). Additionally, or alternatively, the set of one or more erroneous alerting mitigation barriers may include, for example, at least one of a false positive barrier (e.g., a barrier to suppress anomalous detections by the AI application prior to issuing a warning) or a false negative barrier (e.g., a barrier to provide fallback detection, such as through redundancy or post-hoc analysis, to identify suspicious or anomalous events that may have been missed).

In an additional example, the input 314 may indicate that the functional role 316 of the AI application is an AI-assistance role and that the output type 318 is a suggestion delivery type (both of which are associated with a level 3 decision-making capability of the AI application classification framework 102, as shown in FIG. 1). The AI application development system 302 may therefore determine, based on the input 314, that the threat event for the AI application is an erroneous suggestion delivery threat event (e.g., that is associated with the level 3 decision-making capability of the AI application classification framework 102). Accordingly, the AI application development system 302 may cause (e.g., based on determining that the threat event is an erroneous suggestion delivery threat event) a set of one or more erroneous suggestion delivery prevention barriers to be included in the set of one or more prevention barriers. Additionally, or alternatively, the AI application development system 302 may cause (e.g., based on determining that the threat event is an erroneous suggestion delivery threat event) a set of one or more erroneous suggestion delivery mitigation barriers to be included in the set of one or more mitigation barriers.

Accordingly, the set of one or more erroneous suggestion delivery prevention barriers may include, for example, at least one of a low-confidence suggestion prevention barrier (e.g., a barrier to prevent the AI application from issuing suggestions with low confidence, particularly when the potential outcome has serious consequences), or a performance monitoring barrier (e.g., a barrier to require quantifiable performance and error metrics for issued suggestions and/or feedback mechanisms for continuous monitoring of the issued suggestions). Additionally, or alternatively, the set of one or more erroneous suggestion delivery mitigation barriers may include, for example, at least one of a cross-validation error barrier, a false positive barrier, or a false negative barrier (e.g., that are described elsewhere herein).

In an additional example, the input 314 may indicate that the functional role 316 of the AI application is an AI-trusted role and that the output type 318 is an automated decision type (e.g., one of a partially automated decision type, a supervised automated decision type, or a self-supervised automation type) (which are associated with level 4 through 6 decision-making capabilities of the AI application classification framework 102, as shown in FIG. 1). The AI application development system 302 may therefore determine, based on the input 314, that the threat event for the AI application is an erroneous decision threat event (e.g., that is associated with the level 4 through 6 decision-making capabilities of the AI application classification framework 102). Accordingly, the AI application development system 302 may cause (e.g., based on determining that the threat event is an erroneous decision threat event) a set of one or more erroneous decision prevention barriers to be included in the set of one or more prevention barriers. Additionally, or alternatively, the AI application development system 302 may cause (e.g., based on determining that the threat event is an erroneous decision threat event) a set of one or more erroneous decision mitigation barriers to be included in the set of one or more mitigation barriers.

Accordingly, the set of one or more erroneous decision prevention barriers may include, for example, at least one of a trust limit barrier (e.g., a barrier that defines and enforces a scope of decision-making that the AI application is trusted to make), an intervention barrier (e.g., a barrier to trigger human intervention to prevent the AI application from providing an erroneous decision, such as when a potential decision has a low-confidence score or on relies on non-canonical data), a high-confidence decision barrier (e.g., a barrier to measure confidence levels of potential decisions by the AI application and to ensure that only high-confidence decisions are issued), or a risk assessment barrier (e.g., a barrier to identify and mitigate risks associated with issuing potential decisions by the AI application, such as through drift monitoring). Additionally, or alternatively, the set of one or more erroneous decision mitigation barriers may include, for example, at least one of a cross-validation error barrier, a false positive barrier, or a false negative barrier (e.g., that are described elsewhere herein).

As shown in FIG. 3C, and by reference number 356, the AI application development system 302 may generate a development template 320 for developing the AI application (e.g., based on the set of one or more prevention barriers and/or the set of one or more mitigation barriers). The development template 320 is configured to help structure and guide development of the AI application. Accordingly, the AI application development system 302 may generate the development template 320 to include, for each barrier of the set of one or more prevention barriers and/or the set of one or more mitigation barriers, a part that requires provisioning of information relevant to the barrier. That is, each part of the development template 320 requires, for the AI application to be developed, provisioning of information (e.g., configuration details) relevant to a barrier, of the set of one or more prevention barriers and/or the set of one or more mitigation barriers, to enable the barrier to be defined and implemented for the AI application.

As shown by reference number 358, the AI application development system 302 may provide at least a portion of the development template 320 (e.g., via the GUI 306), such as to enable development of the AI application. As shown in FIG. 3C, the AI application development system 302 may provide at least a portion of the development template 320 within the window 308 of the GUI 306, such as within a section 322 (also referred to as a third section 322) of the window 308 of the GUI 306. For example, the AI application development system 302 may update the GUI 306 to include at least a portion of the development template 320 (e.g., within the section 322 of the window 308 of the GUI 306) and may provide the GUI 306 (e.g., after being updated) to the user device 304 (e.g., by sending the GUI 306 to the user device 304), which may cause the user device 304 to display the GUI 306 (e.g., as updated) via the display screen of the user device 304.

By displaying at least part of the development template 320, the user of the user device 304 is made aware of at least one barrier of the set of one or more prevention barriers and/or the set of one or more mitigation barriers, enabling the provision of relevant information for the at least one barrier. For example, the user can interact with the GUI 306 to define and implement the at least one barrier for the AI application. This ensures that the developed AI application includes the at least one barrier, helping to prevent or reduce the likelihood of threat events or minimize potential consequences of the threat event.

As indicated above, FIGS. 3A-3C are provided as an example. Other examples may differ from what is described with regard to FIGS. 3A-3C. The number and arrangement of devices shown in FIGS. 3A-3C are provided as an example. In practice, there may be additional devices, fewer devices, different devices, or differently arranged devices than those shown in FIGS. 3A-3C. Furthermore, two or more devices shown in FIGS. 3A-3C may be implemented within a single device, or a single device shown in FIGS. 3A-3C may be implemented as multiple, distributed devices. Additionally, or alternatively, a set of devices (e.g., one or more devices) shown in FIGS. 3A-3C may perform one or more functions described as being performed by another set of devices shown in FIGS. 3A-3C.

FIG. 4 is a diagram of an example environment 400 in which systems and/or methods described herein may be implemented. As shown in FIG. 4, environment 400 may include the AI application development system 302, which may include one or more elements of and/or may execute within a cloud computing system 402. The cloud computing system 402 may include one or more elements 403-412, as described in more detail below. As further shown in FIG. 4, environment 400 may include a network 420, and/or the user device 304. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the AI application development system 302 may include one or more elements 403-412 of the cloud computing system 402, may execute within the cloud computing system 402, and/or may be hosted within the cloud computing system 402, in some implementations, the AI application development system 302 may not be cloud-based (e.g., may be implemented outside of a cloud computing system) or may be partially cloud-based. For example, the AI application development system 302 may include one or more devices that are not part of the cloud computing system 402, such as device 500 of FIG. 5, which may include a standalone server or another type of computing device. The AI application development system 302 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 304 may include one or more devices capable of receiving, generating, storing, processing, and/or providing information, as described elsewhere herein. The user device 304 may include a communication device and/or a computing device. For example, the user device 304 may include a wireless communication device, a mobile phone, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with using an AI application classification framework to facilitate generation of a development template for an AI application. The device 500 corresponds to one or more of the AI application development system 302 the user device 304, and/or the computing hardware 403. In some implementations, the AI application development system 302 the user device 304, and/or the computing hardware 403 include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

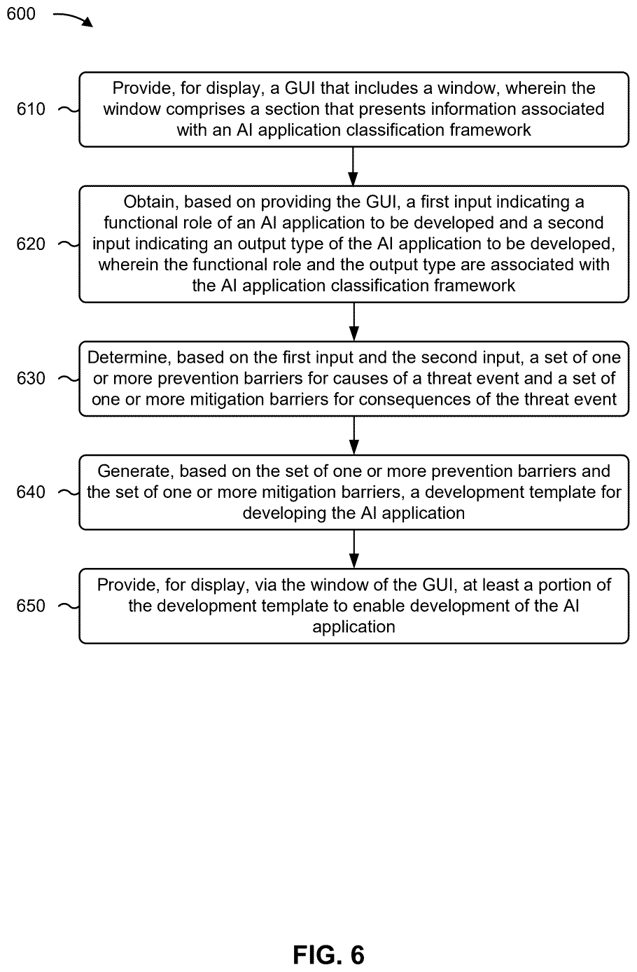

FIG. 6 is a flowchart of an example process 600 associated with using an AI application classification framework to facilitate generation of a development template for an AI application. One or more process blocks of FIG. 6 are performed by an AI application development system (e.g., the AI application development system 302) and/or by another device or a group of devices separate from or including the AI application development system, such as a user device (e.g., the user device 304), and/or the computing hardware (e.g., the computing hardware 403). Additionally, or alternatively, one or more process blocks of FIG. 6 may be performed by one or more components of device 500, such as processor 520, memory 530, input component 540, output component 550, and/or communication component 560.

As shown in FIG. 6, process 600 includes providing, for display, a GUI that includes a window, wherein the window comprises a section that presents information associated with an AI application classification framework (block 610). For example, the AI application development system may provide, for display, a GUI that includes a window, wherein the window comprises a section that presents information associated with an AI application classification framework, as described above. In some aspects, the window comprises a section that presents information associated with an AI application classification framework.

As further shown in FIG. 6, process 600 includes obtaining, based on providing the GUI, a first input indicating a functional role of an AI application to be developed and a second input indicating an output type of the AI application to be developed, wherein the functional role and the output type are associated with the AI application classification framework (block 620). For example, the AI application development system may obtain, based on providing the GUI, a first input indicating a functional role of an AI application to be developed and a second input indicating an output type of the AI application to be developed, as described above. In some aspects, the functional role and the output type are associated with the AI application classification framework.

As further shown in FIG. 6, process 600 includes determining, based on the first input and the second input, a set of one or more prevention barriers for causes of a threat event and a set of one or more mitigation barriers for consequences of the threat event (block 630). For example, the AI application development system may determine, based on the first input and the second input, a set of one or more prevention barriers for causes of a threat event and a set of one or more mitigation barriers for consequences of the threat event, as described above.

As further shown in FIG. 6, process 600 includes generating, based on the set of one or more prevention barriers and the set of one or more mitigation barriers, a development template for developing the AI application (block 640). For example, the AI application development system may generate, based on the set of one or more prevention barriers and the set of one or more mitigation barriers, a development template for developing the AI application, as described above.

As further shown in FIG. 6, process 600 includes providing, for display, via the window of the GUI, at least a portion of the development template to enable development of the AI application (block 650). For example, the AI application development system may provide, for display, via the window of the GUI, at least a portion of the development template to enable development of the AI application, as described above.

Process 600 may include additional aspects, such as any single aspect or any combination of aspects described below and/or in connection with one or more other processes described elsewhere herein.

In a first aspect, the first input indicates that the functional role is an AI-assistance role and the second input indicates that the output type is an information retrieval type, and determining the set of one or more prevention barriers and the set of one or more mitigation barriers includes determining, based on the first input and the second input, that the threat event is an erroneous information retrieval threat event; causing, based on determining that the threat event is an erroneous information retrieval threat event, a set of one or more erroneous information retrieval prevention barriers to be included in the set of one or more prevention barriers; and causing, based on determining that the threat event is an erroneous information retrieval threat event, a set of one or more erroneous information retrieval mitigation barriers to be included in the set of one or more mitigation barriers.

In a second aspect, alone or in combination with the first aspect, the set of one or more erroneous information retrieval prevention barriers includes at least one of a user competence barrier, a usage validation barrier, or a redundancy barrier, and the set of one or more erroneous information retrieval mitigation barriers includes at least one of a cross-validation error barrier, a hallucination barrier, or an incorrect retrieval barrier.

In a third aspect, alone or in combination with one or more of the first and second aspects, the first input indicates that the functional role is an AI-assistance role and the second input indicates that the output type is an alerting type, and determining the set of one or more prevention barriers and the set of one or more mitigation barriers includes determining, based on the first input and the second input, that the threat event is an erroneous alerting threat event; causing, based on determining that the threat event is an erroneous alerting threat event, a set of one or more erroneous alerting prevention barriers to be included in the set of one or more prevention barriers; and causing, based on determining that the threat event is an erroneous alerting threat event, a set of one or more erroneous alerting mitigation barriers to be included in the set of one or more mitigation barriers.

In a fourth aspect, alone or in combination with one or more of the first through third aspects, the set of one or more erroneous alerting prevention barriers includes at least one of a context-aware suppression barrier, or a clarity barrier, and the set of one or more erroneous alerting mitigation barriers includes at least one of a false positive barrier, or a false negative barrier.

In a fifth aspect, alone or in combination with one or more of the first through fourth aspects, the first input indicates that the functional role is an AI-assistance role and the second input indicates that the output type is a suggestion delivery type, and determining the set of one or more prevention barriers and the set of one or more mitigation barriers includes determining, based on the first input and the second input, that the threat event is an erroneous suggestion delivery threat event; causing, based on determining that the threat event is an erroneous suggestion delivery threat event, a set of one or more erroneous suggestion delivery prevention barriers to be included in the set of one or more prevention barriers; and causing, based on determining that the threat event is an erroneous suggestion delivery threat event, a set of one or more erroneous suggestion delivery mitigation barriers to be included in the set of one or more mitigation barriers.

In a sixth aspect, alone or in combination with one or more of the first through fifth aspects, the set of one or more erroneous suggestion delivery prevention barriers includes at least one of a low-confidence suggestion prevention barrier, or a performance monitoring barrier, and the set of one or more erroneous suggestion delivery mitigation barriers includes at least one of a cross-validation error barrier, a false positive barrier, or a false negative barrier.

In a seventh aspect, alone or in combination with one or more of the first through sixth aspects, the first input indicates that the functional role is an AI-trusted role and the second input indicates that the output type is an automated decision type, and determining the set of one or more prevention barriers and the set of one or more mitigation barriers includes determining, based on the first input and the second input, that the threat event is an erroneous decision threat event; causing, based on determining that the threat event is an erroneous decision threat event, a set of one or more erroneous decision prevention barriers to be included in the set of one or more prevention barriers; and causing, based on determining that the threat event is an erroneous decision threat event, a set of one or more erroneous decision mitigation barriers to be included in the set of one or more mitigation barriers.

In an eighth aspect, alone or in combination with one or more of the first through seventh aspects, the set of one or more erroneous decision prevention barriers includes at least one of a trust limit barrier, an intervention barrier, a high-confidence decision barrier, or a risk assessment barrier, and the set of one or more erroneous decision mitigation barriers includes at least one of a cross-validation error barrier, a false positive barrier, or a false negative barrier.

In a ninth aspect, alone or in combination with one or more of the first through eighth aspects, generating the development template includes generating the development template to include, for each barrier of the set of one or more prevention barriers and the set of one or more mitigation barriers, a part that requires provisioning of information relevant to the barrier.

In a tenth aspect, alone or in combination with one or more of the first through ninth aspects, the first input indicates that the functional role is an AI-assistance role, and the second input indicates that the output type is one of an information retrieval type, an alerting type, or a suggestion delivery type.

In an eleventh aspect, alone or in combination with one or more of the first through tenth aspects, the first input indicates that the functional role is an AI-trusted role, and the second input indicates that the output type is one of a partially automated decision type, a supervised automation decision type, or a self-supervised automation type.

In a twelfth aspect, alone or in combination with one or more of the first through eleventh aspects, determining the set of one or more prevention barriers and the set of one or more mitigation barriers includes determining, based on the first input and the second input, that the threat event is a particular type of threat event; causing a set of one or more prevention barriers associated with the particular type of threat event to be included in the set of one or more prevention barriers; and causing a set of one or more mitigation barriers associated with the particular type of threat event to be included in the set of one or more mitigation barriers.

In a thirteenth aspect, alone or in combination with one or more of the first through twelfth aspects, the set of one or more prevention barriers includes at least one of: a user competence barrier, a usage validation barrier, a redundancy barrier, a context-aware suppression barrier, a clarity barrier, a low-confidence suggestion prevention barrier, a performance monitoring barrier, a trust limit barrier, an intervention barrier, a high-confidence decision barrier, or a risk assessment barrier.

In a fourteenth aspect, alone or in combination with one or more of the first through thirteenth aspects, the set of one or more mitigation barriers includes at least one of: a cross-validation error barrier, a hallucination barrier, an incorrect retrieval barrier, a false positive barrier, or a false negative barrier.

In a fifteenth aspect, alone or in combination with one or more of the first through fourteenth aspects, generating the development template includes generating the development template to include a part that requires provisioning of information relevant to a barrier of the set of one or more prevention barriers and the set of one or more mitigation barriers.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

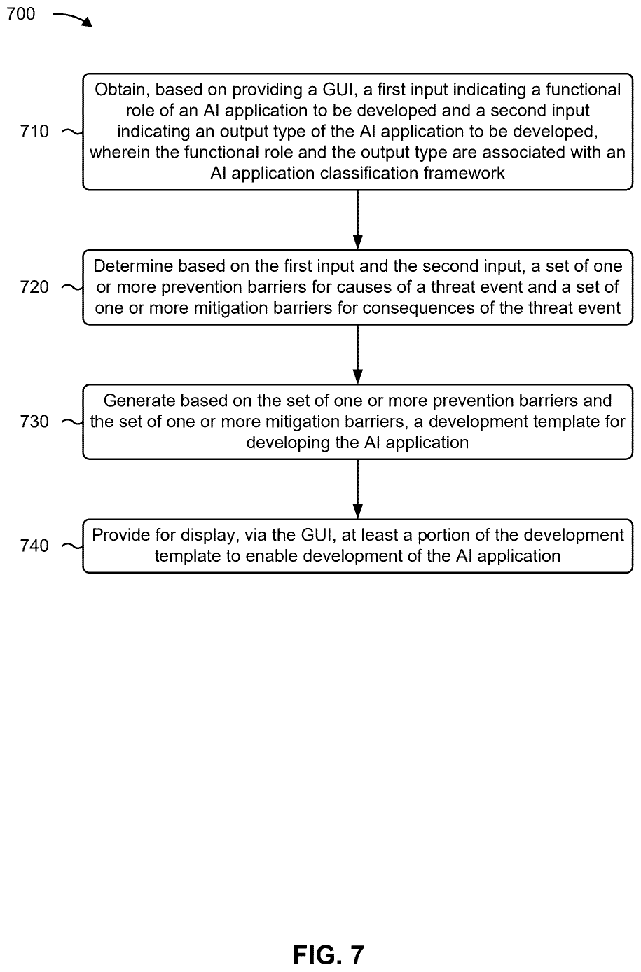

FIG. 7 is a flowchart of an example process 700 associated with using an AI application classification framework to facilitate generation of a development template for an AI application. One or more process blocks of FIG. 7 are performed by an AI application development system (e.g., the AI application development system 302) and/or by another device or a group of devices separate from or including the AI application development system, such as a user device (e.g., the user device 304), and/or the computing hardware (e.g., the computing hardware 403). Additionally, or alternatively, one or more process blocks of FIG. 7 may be performed by one or more components of device 500, such as processor 520, memory 530, input component 540, output component 550, and/or communication component 560.

As shown in FIG. 7, process 700 includes obtaining based on providing a GUI, a first input indicating a functional role of an AI application to be developed and a second input indicating an output type of the AI application to be developed, wherein the functional role and the output type are associated with an AI application classification framework (block 710). For example, the AI application development system may obtain based on providing a GUI) a first input indicating a functional role of an AI application to be developed and a second input indicating an output type of the AI application to be developed, as described above. In some aspects, the functional role and the output type are associated with an AI application classification framework.

As further shown in FIG. 7, process 700 includes determining based on the first input and the second input, a set of one or more prevention barriers for causes of a threat event and a set of one or more mitigation barriers for consequences of the threat event (block 720). For example, the AI application development system may determine based on the first input and the second input, a set of one or more prevention barriers for causes of a threat event and a set of one or more mitigation barriers for consequences of the threat event, as described above.

As further shown in FIG. 7, process 700 includes generating based on the set of one or more prevention barriers and the set of one or more mitigation barriers, a development template for developing the AI application (block 730). For example, the AI application development system may generate based on the set of one or more prevention barriers and the set of one or more mitigation barriers, a development template for developing the AI application, as described above.

As further shown in FIG. 7, process 700 includes providing for display, via the GUI, at least a portion of the development template to enable development of the AI application (block 740). For example, the AI application development system may provide for display, via the GUI, at least a portion of the development template to enable development of the AI application, as described above.

Process 700 may include additional aspects, such as any single aspect or any combination of aspects described below and/or in connection with one or more other processes described elsewhere herein.

In a first aspect, the first input indicates that the functional role is an AI-assistance role, and the second input indicates that the output type is one of an information retrieval type, an alerting type, or a suggestion delivery type.

In a second aspect, alone or in combination with the first aspect, the first input indicates that the functional role is an AI-trusted role, and the second input indicates that the output type is one of a partially automated decision type, a supervised automation decision type, or a self-supervised automation type.

In a third aspect, alone or in combination with one or more of the first and second aspects, determining the set of one or more prevention barriers and the set of one or more mitigation barriers comprises determining, based on the first input and the second input, that the threat event is a particular type of threat event; causing a set of one or more prevention barriers associated with the particular type of threat event to be included in the set of one or more prevention barriers; and causing a set of one or more mitigation barriers associated with the particular type of threat event to be included in the set of one or more mitigation barriers.

In a fourth aspect, alone or in combination with one or more of the first through third aspects, the set of one or more prevention barriers includes at least one of a user competence barrier, a usage validation barrier, a redundancy barrier, a context-aware suppression barrier, a clarity barrier, a low-confidence suggestion prevention barrier, a performance monitoring barrier, a trust limit barrier, an intervention barrier, a high-confidence decision barrier, or a risk assessment barrier.

In a fifth aspect, alone or in combination with one or more of the first through fourth aspects, the set of one or more mitigation barriers includes at least one of a cross-validation error barrier, a hallucination barrier, an incorrect retrieval barrier, a false positive barrier, or a false negative barrier.

In a sixth aspect, alone or in combination with one or more of the first through fifth aspects, generating the development template comprises generating the development template to include a part that requires provisioning of information relevant to a barrier of the set of one or more prevention barriers and the set of one or more mitigation barriers.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

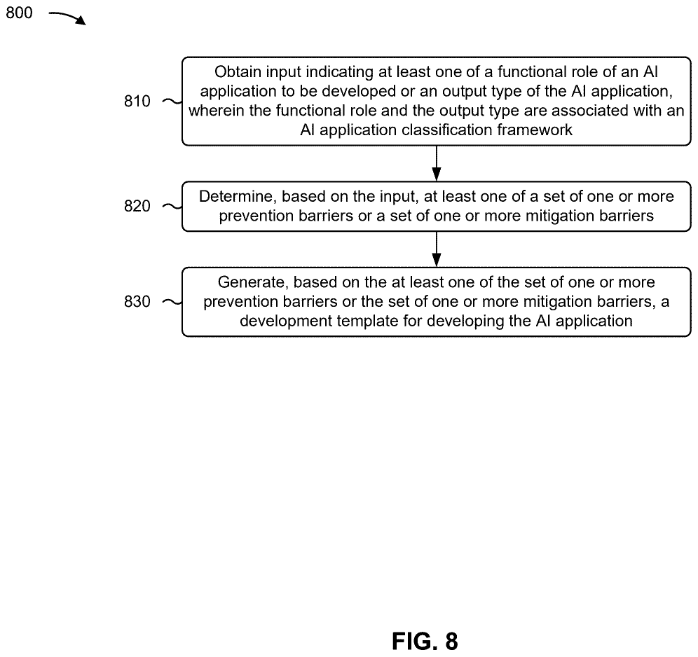

FIG. 8 is a flowchart of an example process 800 associated with using an AI application classification framework to facilitate generation of a development template for an AI application. One or more process blocks of FIG. 8 are performed by an AI application development system (e.g., the AI application development system 302) and/or by another device or a group of devices separate from or including the AI application development system, such as a user device (e.g., the user device 304), and/or the computing hardware (e.g., the computing hardware 403). Additionally, or alternatively, one or more process blocks of FIG. 8 may be performed by one or more components of device 500, such as processor 520, memory 530, input component 540, output component 550, and/or communication component 560.

As shown in FIG. 8, process 800 includes obtaining input indicating at least one of a functional role of an AI application to be developed or an output type of the AI application, wherein the functional role and the output type are associated with an AI application classification framework (block 810). For example, the AI application development system may obtain input indicating at least one of a functional role of an AI application to be developed or an output type of the AI application, as described above. In some aspects, the functional role and the output type are associated with an AI application classification framework.

As further shown in FIG. 8, process 800 includes determining, based on the input, at least one of a set of one or more prevention barriers or a set of one or more mitigation barriers (block 820). For example, the AI application development system may determine, based on the input, at least one of a set of one or more prevention barriers or a set of one or more mitigation barriers, as described above.

As further shown in FIG. 8, process 800 includes generating, based on the at least one of the set of one or more prevention barriers or the set of one or more mitigation barriers, a development template for developing the AI application (block 830). For example, the AI application development system may generate, based on the at least one of the set of one or more prevention barriers or the set of one or more mitigation barriers, a development template for developing the AI application, as described above.

Process 800 may include additional aspects, such as any single aspect or any combination of aspects described below and/or in connection with one or more other processes described elsewhere herein.

In a first aspect, process 800 includes providing, for display, a GUI, and obtaining the input based providing the GUI.

In a second aspect, alone or in combination with the first aspect, process 800 includes generating the development template to include a part that requires provisioning of information relevant to a barrier of the at least one of the set of one or more prevention barriers or the set of one or more mitigation barriers.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations described herein to the precise forms that are described. Modifications and variations can be made in light of the above description or may be acquired from practice of the implementations described herein.

As used herein, the term “component” is intended to be broadly construed as hardware, firmware, and/or a combination of hardware and software. It will be apparent that systems and/or methods described herein can be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

Even though particular combinations of features are recited in the claims and/or described in the specification, these combinations are not intended to limit the implementations described herein. In fact, many of these features can be combined in ways not specifically recited in the claims and/or described in the specification. For example, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, or a combination of related and unrelated items,), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and can be used interchangeably with “and/or,” unless explicitly stated otherwise (e.g., if used in combination with “either” or “only one of”).

What is claimed is:

1. An artificial intelligence (AI) application development system, comprising:
one or more memories; and
one or more processors, communicatively coupled to the one or more memories, configured to:
provide, for display, a graphical user interface (GUI) that includes a window,
wherein the window comprises a section that presents information associated with an AI application classification framework;
obtain, based on providing the GUI, a first input indicating a functional role of an AI application to be developed and a second input indicating an output type of the AI application to be developed,
wherein the functional role and the output type are associated with the AI application classification framework;
determine, based on the first input and the second input, a set of one or more prevention barriers for causes of a threat event and a set of one or more mitigation barriers for consequences of the threat event;
generate, based on the set of one or more prevention barriers and the set of one or more mitigation barriers, a development template for developing the AI application;
and provide, for display, via the window of the GUI, at least a portion of the development template to enable development of the AI application.

2. The AI application development system of claim 1, wherein the first input indicates that the functional role is an AI-assistance role and the second input indicates that the output type is an information retrieval type, and
wherein the one or more processors, to determine the set of one or more prevention barriers and the set of one or more mitigation barriers, are configured to:
determine, based on the first input and the second input, that the threat event is an erroneous information retrieval threat event;
cause, based on determining that the threat event is an erroneous information retrieval threat event, a set of one or more erroneous information retrieval prevention barriers to be included in the set of one or more prevention barriers; and
cause, based on determining that the threat event is an erroneous information retrieval threat event, a set of one or more erroneous information retrieval mitigation barriers to be included in the set of one or more mitigation barriers.

3. The AI application development system of claim 2, wherein:
the set of one or more erroneous information retrieval prevention barriers includes at least one of:
a user competence barrier,
a usage validation barrier, or
a redundancy barrier, and
the set of one or more erroneous information retrieval mitigation barriers includes at least one of:
a cross-validation error barrier,
a hallucination barrier, or
an incorrect retrieval barrier.

4. The AI application development system of claim 1, wherein the first input indicates that the functional role is an AI-assistance role and the second input indicates that the output type is an alerting type, and
wherein the one or more processors, to determine the set of one or more prevention barriers and the set of one or more mitigation barriers, are configured to:
determine, based on the first input and the second input, that the threat event is an erroneous alerting threat event;
cause, based on determining that the threat event is an erroneous alerting threat event, a set of one or more erroneous alerting prevention barriers to be included in the set of one or more prevention barriers; and
cause, based on determining that the threat event is an erroneous alerting threat event, a set of one or more erroneous alerting mitigation barriers to be included in the set of one or more mitigation barriers.

5. The AI application development system of claim 4, wherein:
the set of one or more erroneous alerting prevention barriers includes at least one of:
a context-aware suppression barrier, or
a clarity barrier, and
the set of one or more erroneous alerting mitigation barriers includes at least one of:
a false positive barrier, or
a false negative barrier.

6. The AI application development system of claim 1, wherein the first input indicates that the functional role is an AI-assistance role and the second input indicates that the output type is a suggestion delivery type, and
wherein the one or more processors, to determine the set of one or more prevention barriers and the set of one or more mitigation barriers, are configured to:
determine, based on the first input and the second input, that the threat event is an erroneous suggestion delivery threat event;
cause, based on determining that the threat event is an erroneous suggestion delivery threat event, a set of one or more erroneous suggestion delivery prevention barriers to be included in the set of one or more prevention barriers; and
cause, based on determining that the threat event is an erroneous suggestion delivery threat event, a set of one or more erroneous suggestion delivery mitigation barriers to be included in the set of one or more mitigation barriers.

7. The AI application development system of claim 6, wherein:
the set of one or more erroneous suggestion delivery prevention barriers includes at least one of:
a low-confidence suggestion prevention barrier, or
a performance monitoring barrier, and
the set of one or more erroneous suggestion delivery mitigation barriers includes at least one of:
a cross-validation error barrier,
a false positive barrier, or
a false negative barrier.

8. The AI application development system of claim 1, wherein the first input indicates that the functional role is an AI-trusted role and the second input indicates that the output type is an automated decision type, and
wherein the one or more processors, to determine the set of one or more prevention barriers and the set of one or more mitigation barriers, are configured to:
determine, based on the first input and the second input, that the threat event is an erroneous decision threat event;
cause, based on determining that the threat event is an erroneous decision threat event, a set of one or more erroneous decision prevention barriers to be included in the set of one or more prevention barriers; and
cause, based on determining that the threat event is an erroneous decision threat event, a set of one or more erroneous decision mitigation barriers to be included in the set of one or more mitigation barriers.

9. The AI application development system of claim 8, wherein:
the set of one or more erroneous decision prevention barriers includes at least one of:
a trust limit barrier,
an intervention barrier,
a high-confidence decision barrier, or
a risk assessment barrier, and
the set of one or more erroneous decision mitigation barriers includes at least one of:
a cross-validation error barrier,
a false positive barrier, or
a false negative barrier.

10. The AI application development system of claim 1, wherein the one or more processors, to generate the development template, are configured to:
generate the development template to include, for each barrier of the set of one or more prevention barriers and the set of one or more mitigation barriers, a part that requires provisioning of information relevant to the barrier.

11. A method, comprising:
obtaining, by an artificial intelligence (AI) application development system, based on providing a graphical user interface (GUI), a first input indicating a functional role of an AI application to be developed and a second input indicating an output type of the AI application to be developed,
wherein the functional role and the output type are associated with an AI application classification framework;
determining, by the AI application development system, based on the first input and the second input, a set of one or more prevention barriers for causes of a threat event and a set of one or more mitigation barriers for consequences of the threat event;
generating, by the AI application development system, based on the set of one or more prevention barriers and the set of one or more mitigation barriers, a development template for developing the AI application; and
providing, by the AI application development system, for display, via the GUI, at least a portion of the development template to enable development of the AI application.

12. The method of claim 11, wherein:
the first input indicates that the functional role is an AI-assistance role, and
the second input indicates that the output type is one of an information retrieval type, an alerting type, or a suggestion delivery type.

13. The method of claim 11, wherein:
the first input indicates that the functional role is an AI-trusted role, and
the second input indicates that the output type is one of a partially automated decision type, a supervised automation decision type, or a self-supervised automation type.

14. The method of claim 11, wherein determining the set of one or more prevention barriers and the set of one or more mitigation barriers comprises:
determining, based on the first input and the second input, that the threat event is a particular type of threat event;
causing a set of one or more prevention barriers associated with the particular type of threat event to be included in the set of one or more prevention barriers; and
causing a set of one or more mitigation barriers associated with the particular type of threat event to be included in the set of one or more mitigation barriers.

15. The method of claim 11, wherein the set of one or more prevention barriers includes at least one of:
a user competence barrier,
a usage validation barrier,
a redundancy barrier,
a context-aware suppression barrier,
a clarity barrier,
a low-confidence suggestion prevention barrier,
a performance monitoring barrier,
a trust limit barrier,
an intervention barrier,
a high-confidence decision barrier, or
a risk assessment barrier.

16. The method of claim 11, wherein the set of one or more mitigation barriers includes at least one of:
a cross-validation error barrier,
a hallucination barrier,
an incorrect retrieval barrier,
a false positive barrier, or
a false negative barrier.

17. The method of claim 11, wherein generating the development template comprises:
generating the development template to include a part that requires provisioning of information relevant to a barrier of the set of one or more prevention barriers and the set of one or more mitigation barriers.

18. A non-transitory computer-readable medium storing a set of instructions, the set of instructions comprising:
one or more instructions that, when executed by one or more processors of an artificial intelligence (AI) application development system, cause the AI application development system to:
obtain input indicating at least one of a functional role of an AI application to be developed or an output type of the AI application,
wherein the functional role and the output type are associated with an AI application classification framework;
determine, based on the input, at least one of a set of one or more prevention barriers or a set of one or more mitigation barriers; and
generate, based on the at least one of the set of one or more prevention barriers or the set of one or more mitigation barriers, a development template for developing the AI application.

19. The non-transitory computer-readable medium of claim 18, wherein the one or more instructions, that cause the AI application development system to obtain the input, cause the AI application development system to:
provide, for display, a graphical user interface (GUI); and
obtain the input based providing the GUI.

20. The non-transitory computer-readable medium of claim 18, wherein the one or more instructions, that cause the AI application development system to generate the development template, cause the AI application development system to:
generate the development template to include a part that requires provisioning of information relevant to a barrier of the at least one of the set of one or more prevention barriers or the set of one or more mitigation barriers.
